(19) United States
(12) Patent Application Publication
(10) Pub. No.: US 2007/0244859 A1
(43) Pub. Date: Oct. 18, 2007

(54) Method and system for displaying relationship between structured data and unstructured data

(75) Inventors: Anthony J. Trippe, Dublin, OH (US); Jeffrey V. Fisher, Plain City, OH (US); William F. Bartelt III, Worthington, OH (US); Roger James Schenck, Columbus, OH (US); Kirk Crandall Schwall, Gahanna, OH (US); Jay P. Vondran, Hilliard, OH (US); Todd A. Hill, Columbus, OH (US); James A. Vorbau, Delaware, OH (US); Stephen D. Powers, Moraga, CA (US)

Correspondence Address: FOLEY AND LARDNER LLP;SUITE 500, 3000 K STREET NW, WASHINGTON, DC, 20007, US

(73) Assignee: American Chemical Society

(21) Appl. No.: 11/403,195

(22) Filed: Apr. 13, 2006

(51) Int. Cl. G06F 17/30

(52) U.S. Cl. 707/3

(57) ABSTRACT

A method, system, and software of relating structured data to unstructured data includes displaying unstructured data in a first display area and displaying structured data related to the unstructured data in a second display area. In response to a change in the display of one of the unstructured data in the first display area or the structured data in the second display area, automatically dynamically changing the display in the other of the first display area or the second display area to display changed data based on its relation to the changed data in the one of the first display area or the second display area.

### BACKGROUND OF THE INVENTION

The invention relates to a system and method for dynamically and graphically relating unstructured or un-fielded data with structured or fielded database search results. Both the unstructured data and the structured data may be obtained from suitable database search results.

Current database tools generally allow a user to perform searches on database contents based on structured database contents. For example, entries into a database may be searchable based on certain fields or criteria that have been populated for a particular entry in the database. In addition, database tools exist which offer a user the ability to perform a search of database contents based on unstructured database contents. An example of an unstructured search may be a text search that seeks the appearance of a particular word, phrase, of group of words within a database entry. Because the text of a database entry does not appear in any particular field, the text of a database entry is said to be un-fielded or unstructured. One of the problems with known database management tools is that the database often contains vast amounts of data that is too vast for a user to process. Efficient means of analyzing and understanding the data stored in a database is difficult as relationships between unstructured data (for example, text) and structured data (for example, fields in a database) is not readily apparent to the user.

### SUMMARY OF THE INVENTION

In certain embodiments, a computer implemented method of relating structured data to unstructured data, includes the steps of: displaying unstructured data in a first display area; displaying structured data related to the unstructured data in a second display area; in response to a change in the display of either the unstructured data in the first display area or the structured data in the second display area, automatically dynamically changing the display in the other of the first display area or the second display area to display the changed data based on its relation to the changed data in the one of the first display area or the second display area.

In certain embodiments, displaying the unstructured data includes performing a search of one or more databases to retrieve the unstructured data displayed in the first display area.

In certain embodiments, the step of displaying the structured data includes retrieving structured data from the one or more databases based on its association with the unstructured data retrieved from the one or more databases.

In certain embodiments, the step of displaying structured data is performed automatically responsive to the step of displaying unstructured data.

In certain embodiments, the step of displaying the unstructured data includes displaying a cluster map of retrieved data in which similar data based on one or more attributes of the retrieved data are grouped together in similar clusters.

In certain embodiments, the step of displaying the unstructured data includes displaying a classification scheme of the retrieved data in which similar data based on one or more attributes of the retrieved data are grouped together in similar classifications.

In certain embodiments, the step of displaying structured data includes displaying a one-dimensional display based on an attribute of the retrieved data displayed in the first display area.

In certain embodiments, the step of displaying the structured data includes displaying a two-dimensional display based on two attributes of the retrieved data displayed in the first display area.

In certain embodiments, the first display area and the second display area are respective windows in a graphical user interface on a computer display.

In certain embodiments, the display in any two of the first display area, the second display area, and a third display area are automatically dynamically changed to reflect a changed display in the other of the first display area, the second display area, and the third display area.

In certain embodiment, the first display area displays a cluster map of documents clustered based on concept indicators associated with each document, the second display area displays a one-dimensional display that displays one attribute associated with the documents in the cluster map displayed in the first display area, and the third display area displays a multi-dimensional display that displays at least two attributes associated with the documents in the cluster map displayed in the first display area.

In certain embodiments, the method further includes receiving a selection of a subset of data in one of the first display area, second display area, or the third display area, and automatically dynamically highlighting the data in the others of the first, second, and third display areas that correspond to the selected subset of data in the one of the first display area, the second display area, and the third display area.

In certain embodiments, the method further includes providing a document viewer display area in which specific documents included in the unstructured data or lists of documents included in the unstructured data may be viewed, wherein the list of documents displayed in the document viewer display area corresponds to a selection made in one of the first display area or the second display area.

In certain embodiments, a system is provided for relating structured data to unstructured data, which includes: a display unit configured to display unstructured data in a first display area; the display unit also configured to display structured data related to the unstructured data in a second display area; and a processing unit configured, in response a change in the display of one of the unstructured data in the first display area or the structured data in the second display area, to automatically dynamically change the display in the other of the first display area or the second display area to display changed data based on its relation to the changed data in the one of the first display area or the second display area.

In certain embodiments, a computer readable medium is provided having program code recorded thereon that, when executed on a computing system, relates structured data to unstructured data, the program code including: code for displaying unstructured data in a first display area; code for displaying structured data related to the unstructured data in a second display area; code for, in response a change in the display of one of the unstructured data in the first display area or the structured data in the second display area, automatically dynamically changing the display in the other of the first display area or the second display area to display changed data based on its relation to the changed data in the one of the first display area or the second display area.

### BRIEF DESCRIPTION OF THE DRAWINGS

The accompanying drawings, which are incorporated in and constitute a part of the specification, illustrate embodiments of the invention and together with the description, serve to explain the principles of the invention.

FIG. 1 is flowchart describing the steps of one embodiment of the present invention.

FIG. 2 is a block diagram illustrating the system components of one embodiment.

FIG. 2A is a diagram that illustrates the process of harmonizing data.

FIGS. 3 and 4 are diagrams that show different search strategies that may be used in certain embodiments.

FIGS. 5A and 5B together are a workspace display in one embodiment.

FIG. 6 is a display of a one-dimensional bar chart in one embodiment.

FIG. 7 is a two-dimensional matrix chart in one embodiment.

FIGS. 8 and 9 are two views of a research landscape display in one embodiment.

FIGS. 10A and 10B are together a workspace display showing the interaction between four display areas in one embodiment.

FIG. 11 is a display of a data cleaning window used in one embodiment.

FIG. 12 is workspace display displaying interaction of the display areas in one embodiment.

### DETAILED DESCRIPTION OF THE EMBODIMENTS

In a general aspect, the present invention provides a system, method, and software that dynamically and graphically relates unstructured data to structured data and provides a dynamic display of the relationship between the unstructured data and the structured data.

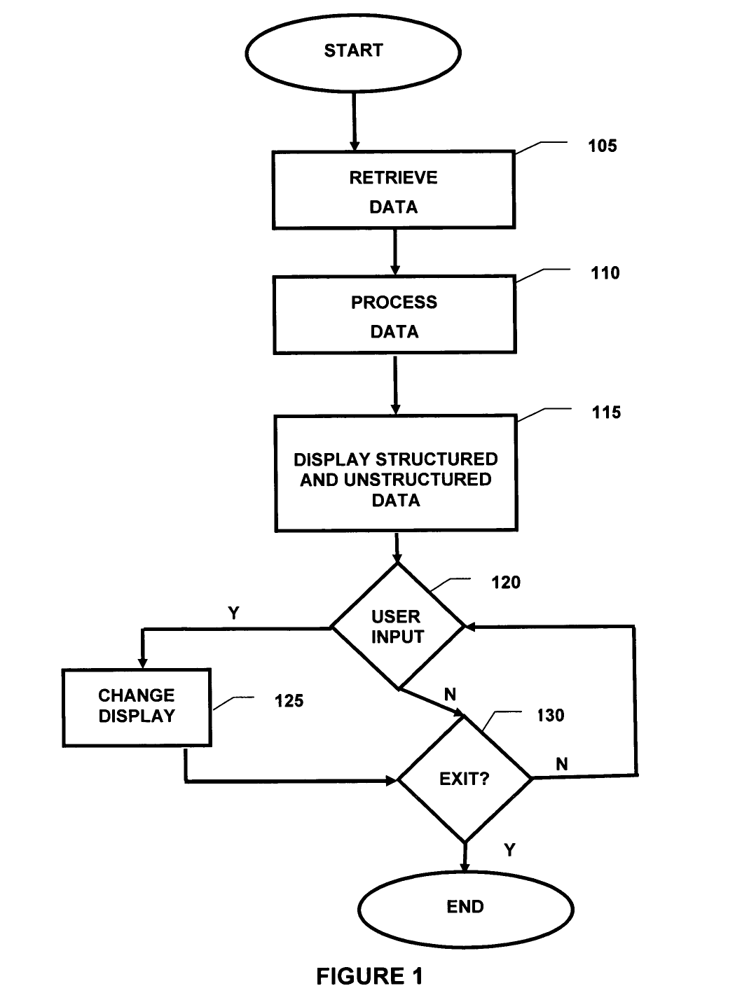

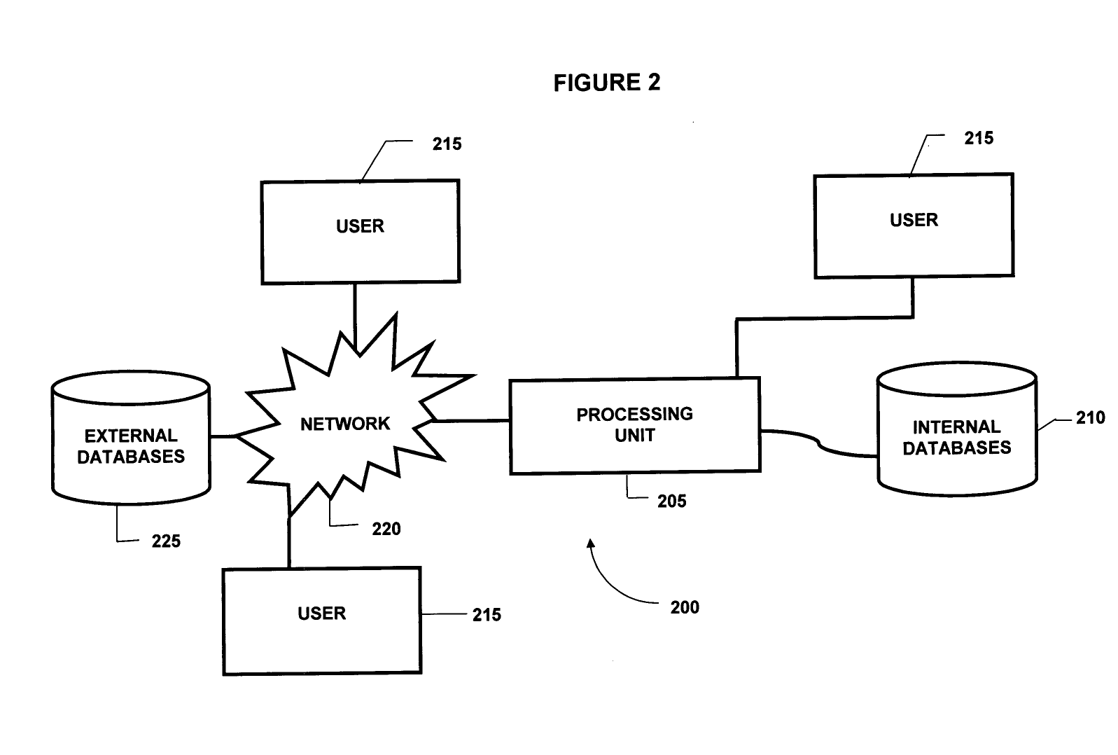

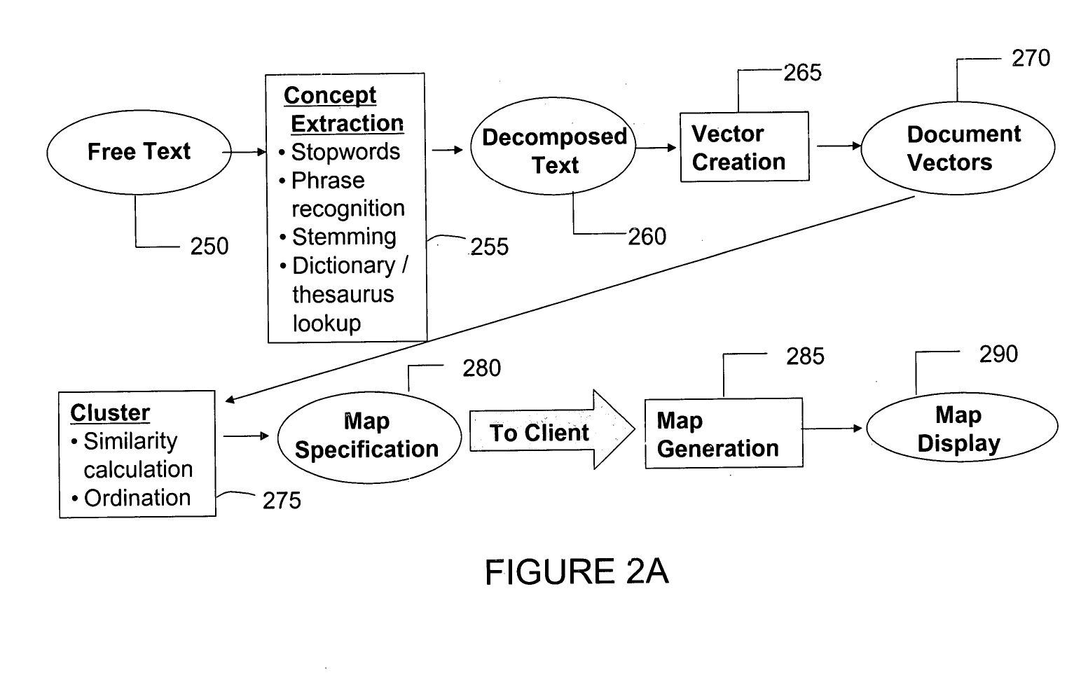

FIG. 1 is a flowchart that illustrates the process flow in one embodiment of the present invention in which meaningful data is retrieved and presented to a user. FIG. 2 is a block diagram of the system components in one embodiment of the present invention. It should be noted that the FIGS. 1 and 2 are exemplary only and one skilled in the art would recognize various modifications and alternatives which are all considered a part of the present invention.

As shown in FIG. 2, the system 200 includes a processing unit 205 (which is a computing system that may be implemented in a distributed architecture) which is programmed to implement the logic of the method steps discussed further herein and includes memory, input-output devices and network connectivity as is well known to those skilled in the art. The processing unit 205 may be accessed by local users 215 or other user 215 over a public or private network 220. The users 215 have a computing unit or terminal including a display unit in which multiple display areas may be formatted and displayed. The processing unit 205 also accesses both internal databases 210 (which means any database that the system has permission to access of its own accord) and may be connected to external databases 225 for which a user permission or login may be required.

With reference to the flowchart of FIG. 1, in step 105, the system (for example, implemented in the processing unit 205) retrieves data responsive to a user request (for example, a user 215). In certain embodiments, the system provides two methods by which a user 215 can request for the data to be gathered. First, the user 215, may access an external database 225 (such as commercial databases like Lexis or Compuserve or a company's proprietary database), and retrieve data using the retrieval interface provided by the external database 225. In this situation, the data retrieved from the external database 225 needs to be imported or formatted for use with the system provided herein. For example, the data retrieved from the external databases 225 (or data sources) may be saved in a local file (on the desktop or on a network drive) associated with the user 215 and the system (for example, the processing unit 205) provided herein may then access this file to import the data into the system by formatting the data so that it can be used by the system.

Second, the user may use a search or query interface provided by the system in which the user can access and retrieve data from databases and data sources to which the system is connected (for example, the internal databases 210). One of the features of the system provided herein is that if the search or query interface of the system is used, the data from external or internal databases or data sources is automatically formatted for use with system so that no separate importation or formatting process is necessary. One skilled in the art would recognize that, in certain embodiments, a user may use both the first and second methods together to retrieve the data so that the coverage of databases and data sources is maximized.

In step 110, the data that is retrieved responsive to the user's request is processed by the system to provide the interrelated display of the structured data and unstructured data. One skilled in the art would recognize that the data could also be requested by more than one user and all the data so requested may be used for the display provided by the system of the present invention. This could be accomplished by, for example, defining groups or projects so that data could be specified by several users and the processing could be done on all the data that is included in a particular group or project.

Initially, the data that is retrieved is harmonized so that data that is retrieved from different databases or data sources is treated consistently by the system. For example, the structured fields associated with documents from different databases may have slightly different field names or formats. Therefore, the process of harmonization may change some of these field names to a standard name for fields of a certain type or update a reference table that shows the interrelationships between the different field names so that the subsequent processing of the data treats the similar fields semantically the same way even if the field names or formats are different across the different databases or data sources that are accessed by the system.

FIG. 2A is a flow diagram that provides details of the harmonization process in conjunction with clustering as performed in certain embodiments of the system 200. In this embodiment, the harmonization is done based on concept or other attributes that are derived from the unstructured data. For example, the free text in a document 250 (as an example of unstructured data) is processed by a software based concept extraction process 255. In the concept extraction process, stop words and specific phrases are recognized using stemming where necessary and optionally by looking up a dictionary or thesaurus. Specific words in the concept extraction process 255 are written as decomposed text 260 which is used in a vector creation process 265 which creates a document vector 270 associated with a document. In certain embodiments, a document vector contains a list of concept words while in other embodiments, the vector could have concepts as well as a measure of the strength of the presence of the concept in the document (for example, based on a count of a number of words or word instances that correspond to a particular concept).

In step 275, the document vectors are used to cluster together documents based on a similarity of the document vectors of the various documents. In addition, ordination, K-means, and/or other techniques may be used which are other clustering techniques that are well known to those skilled in the art. Some clustering techniques that may be used are: Hierarchical, nearest neighbor, support vector machine, self-organizing maps.

Returning to FIG. 1, in step 110, the data required to format and create the display of the unstructured data (in a first display area) and the display of the structured data (in at least a second display area) are derived. For example, the first display area may display the retrieved unstructured data (for example, documents) in a research landscape map. In one embodiment, the research landscape map may be a cluster map that displays clusters of the retrieved unstructured data (or documents) which are clustered based on a similarity value of one or more concept indicators. The concept indicators may be associated with each document retrieved by being stored as metadata related to that document. For example, a document vector may be stored associated with each document in which the elements of the vectors indicate the presence and/or strength of one or more of the concept indicators. If the retrieved data (or documents) do not have metadata available apriori, the system may generate such metadata by reviewing the attributes of the document, for example, by using text mining software that reviews the keywords associated with the document or looks for the presence or absence of specific word sequences in the text of the documents.

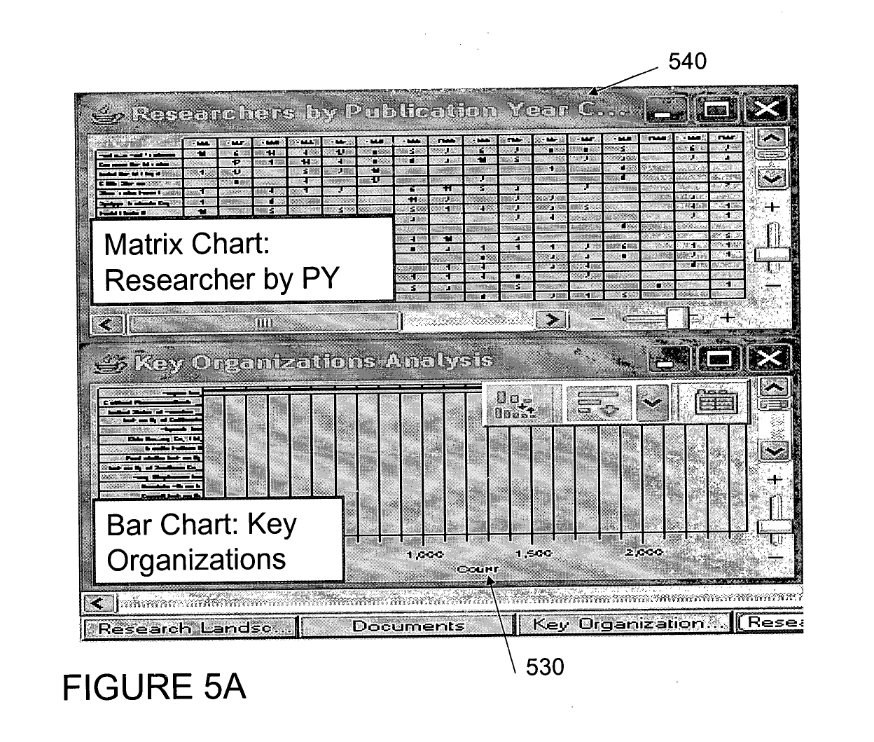

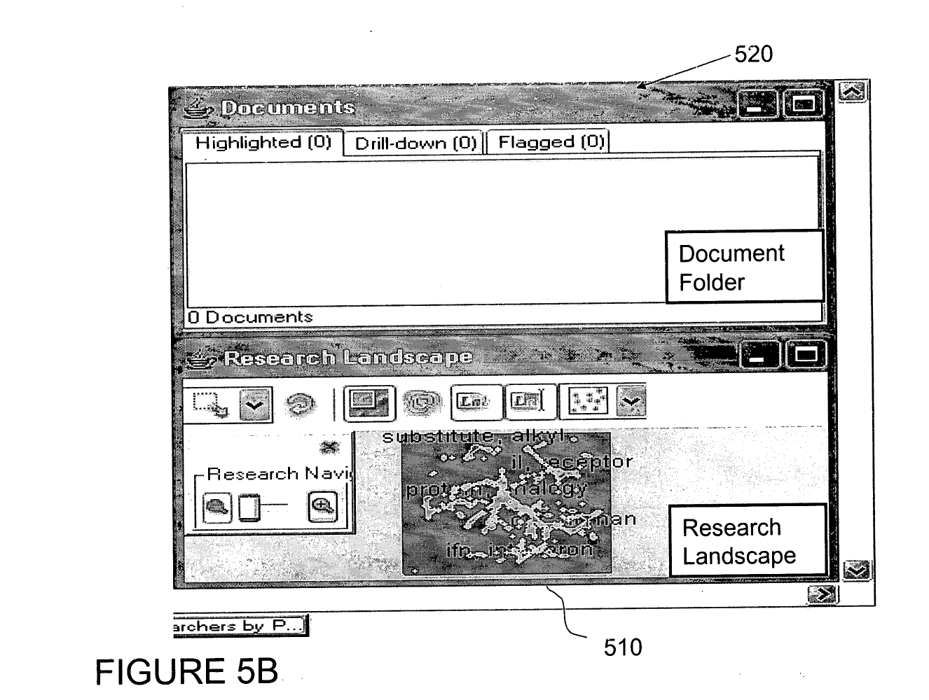

In the research landscape display 510 (FIG. 5A), the data or documents having similar values for certain data attributes that are related, for example, to the original search queries of the user, are clustered together. Alternatively, the user may separately provide an indication of the concept indicators that should be used to cluster the unstructured data or documents. Preferably, in addition to the spatial layout data based on the clustering, the system also calculates and uses a measure of the strength of the particular concept indicators that are used for clustering the research landscape map. Accordingly, the research landscape map, in certain embodiments, uses a three or more dimensional display to provide an indication of the number and/or strength of the data (or documents) that make up a particular cluster. Therefore, for example, a cluster with many documents may be indicated by a greater height peak than a cluster with fewer documents that are displayed as a cluster having a lower height peak when compared to the cluster having a larger number of documents. Furthermore, the distance between any two clusters may be an indication of the degree of similarity between the clusters.

In certain embodiments, the research landscape display may instead display the unstructured data (for example, documents) arranged in a classification scheme in which a document is classified into one of the categories or groups of the classification scheme.

The structured data related to the unstructured data needs to be organized so that they can be displayed in one or more display areas (i.e., a second and/or third display area or additional display areas). In one embodiment, the structured data related to the unstructured data may be displayed using a one-dimensional display, such as a bar chart. Therefore, for example, if the documents retrieved are patents, the bar chart may provide a display of the assignees of the patents in which the length of the bar indicates the number of patents assigned to that assignee. It should be noted that there could be multiple instances of any one of the display areas discussed herein. Therefore, for example, multiple bar charts (based on different attributes) or multiple research landscape displays could be provided in certain embodiments.

In certain embodiments, the structured data may also be displayed in a two-dimensional display, such as, a matrix. In this display, the documents retrieved responsive to the user's request may be classified based on two attributes (which are the axes of the matrix). For example, if the retrieved data is patents, the matrix display may display the assignees correlated to the technical field of the patents so that one can visually assess not only the assignees that are active but also the technical fields in which the assignees have focused their patents. Likewise, it should be noted that multiple instances of the second display area could be displayed at the same time. Furthermore, it should be noted that certain embodiments could also display a multi-dimensional display having more than two dimensions. For example, graphical constructs such as circle graphs could be used to generate a multi-dimensional display that displays information in more than two dimensions.

In certain embodiments, the system also provides a document viewer in which a specified document can be viewed in full (or in significant sections). Therefore, if the user selects a particular document in any one of the other display areas, the document viewer automatically retrieves and displays that particular document. Alternatively, or in addition, the document viewer may, by default, display a list of documents that have been retrieved in a searchable and indexed display. Therefore, a user may be able to select a document from the list in the document window itself so that the document can then be displayed in the document window.

In certain embodiments, the document viewer display area may include several tabs (or other similar indicators) that enable a user to control the documents displayed in the document viewer display area. For example, a “highlighted” tab can be provided which lists the specific documents that are in a selected state in one of the other display areas and this list of specific documents will change each time the selected state changes in one of the other display areas. A “drill down” tab provides a user the ability to drill down on a list of documents or select a specific document for viewing. A “flagged” tab allows a user to select one or more documents that are kept in the document list in the document viewer display area irrespective of the selection state of those documents in the other display areas. Therefore, the flagged documents are kept accessible in the list of documents displayable in the document viewer display area irrespective of the selection state of the documents in one or more of the other display areas.

With reference to FIG. 1, once the data has been processed in step 110, the structured and unstructured display are displayed in two or more display areas which may, for example, be two or more windows in a graphical user interface. Therefore, the research landscape map may be displayed in a first display area, while the bar chart and the matrix may be displayed in a second and third display area. The document viewer may also be displayed in a separate display area.

It should be noted that the system 200 provides that these various display areas, for example, the first, second, third and document viewer display areas are displayed in a logical workspace. In certain embodiments, the entire workspace including all the display areas are displayed on the display of a single computing system or other similar display. Alternatively, the workspace may be physically distributed over two or more computer displays (or other similar display) so that some of the display areas are displayed on one computer display while the other display areas are displayed on another computer display. However, the display areas are still dynamically interoperable in the manner described herein even if the display areas are physically displayed on different computer or other similar displays. In certain embodiments, a display unit includes a graphical user interface which independently controls and formats the first display area and the second display area. For example, the first display area and the second display area may be separate windows, frames, or panels or combinations thereof which are interoperable in the manner discussed herein.

In step 120, the system checks to see if there is any user input. For example, the user may select one of the clusters in the research landscape map or one of the attributes displayed in the structured data displays (for example, the bar chart or the matrix display). If there is no input, the system checks to see if the user has indicated that the session should be terminated in step 130 and if not returns to check for user input in step 120.

If user input is detected in step 120, the method proceeds to step 125 in which the display automatically and dynamically changes in response to the user input. For example, if the user selects one of the clusters in the research landscape map in the first display area, that cluster may be highlighted or otherwise indicated in the research landscape map in the first display area. The bar chart in the second display area is also substantially simultaneously updated to reflect the selected cluster in the first display area so that the corresponding data elements in the bar chart are also highlighted or otherwise indicated. Likewise, the matrix display in the third display area is also substantially simultaneously updated to reflect the selected cluster in the first display area. Furthermore, the document viewer may also be updated to reflect or highlight the documents that correspond to the selected cluster in the first display area.

It should be noted that while the above discussion discloses that a change in the first display area is automatically and dynamically reflected in the other display areas, the initial change or selection could be made to any one of the display areas and the other display areas would automatically and dynamically change their display in response.

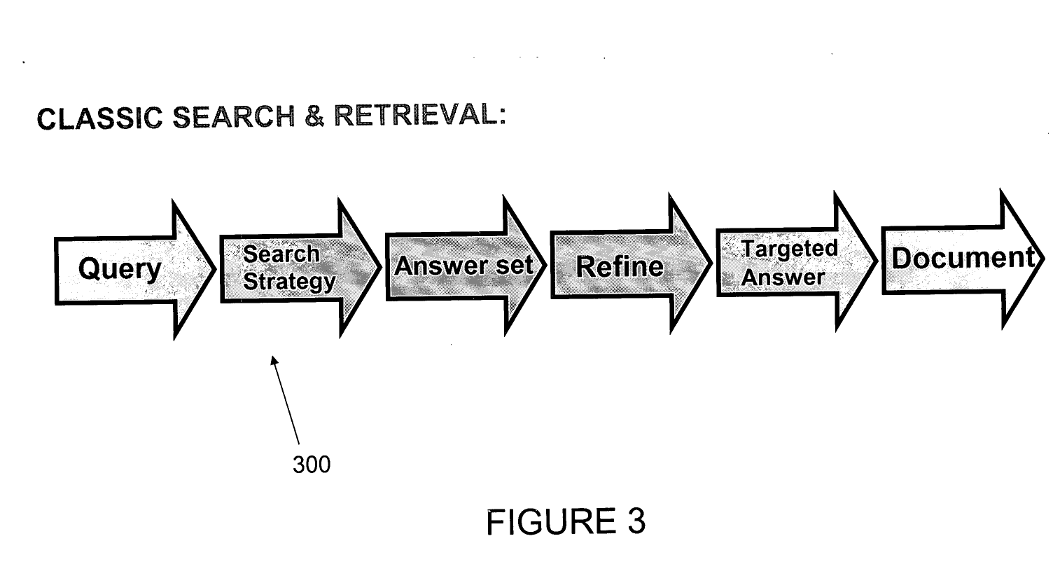

FIGS. 3-14 are diagrams that show the features and display changes in a few embodiments of the invention. As shown in FIG. 3, a classic search and retrieval process proceeds from a query to a search strategy which retrieves an answer set. The answer set is then refined by the user to get a more targeted answer set from which one or more documents are retrieved.

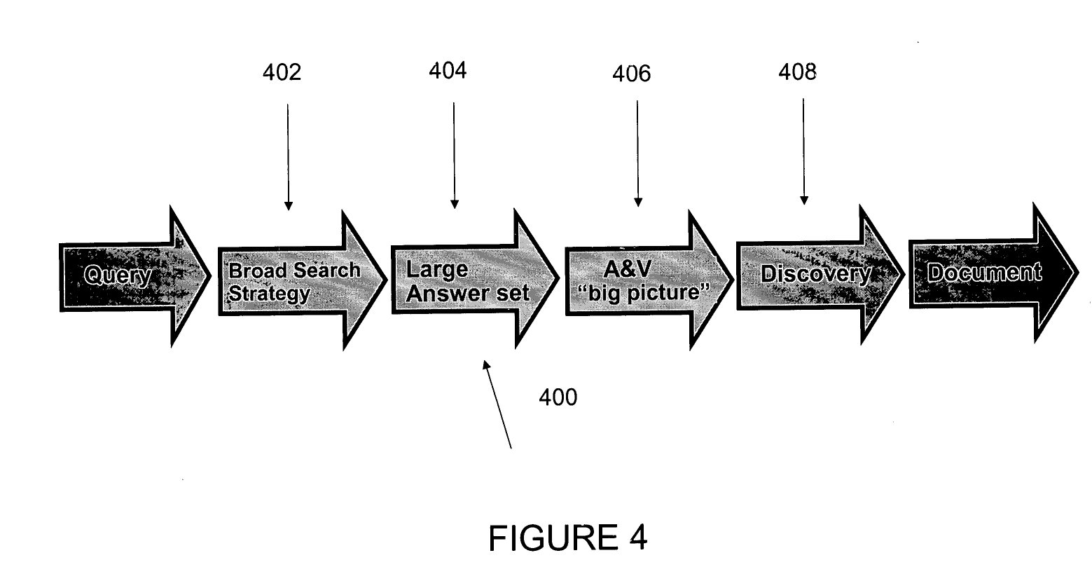

FIG. 4 shows the search and display feature of certain embodiments of the system 200. An initial query is used to set up a broad search strategy 402 in which the search terms (or other similar parameters) provided by a user are augmented to provide a large answer set 404. For example, the search terms provided by a user are augmented by using additional terms that correspond to the user's search terms by using a database that is provided with such additional or similar search terms. Alternatively or in addition, the broad search strategy may focus on concept indicators to search for all documents that match the specific concept indicators that correspond to a user's search terms.

Once the large answer set 404 has been retrieved, the system 200 provides a display that provides a multi-window display areas of the results in which each of the windows cooperatively display various aspects of the answer set. For example, one of the display areas displays a research landscape of the retrieved documents by clustering documents into the relevant clusters, for example, based on the concept indicators. Other display areas display one or more attributes of the documents in the answer set so that a user may iterate through a discovery stage 408 in which the user is able to analyze the documents based on the correlated changes in the display areas (which may be GUI windows in certain embodiments). In this way, a user is able to identify relevant documents from a larger and more relevant answer set based on criteria that better matches a user's search strategy.

In certain embodiments, the system 200 provides that two or more selections can be active in the selected state in one or more of the display areas. If two sets of data are to be displayed in a single display area (based on the fact that there are two active selected states), the data corresponding to each of the selections could be color coded to be different or the brightness of the data could be varied to reflect which selected state the data corresponds. Data that belongs to both selected states could be easily tracked by displaying a third color that may correspond to a combination of the colors for the other two selected states.

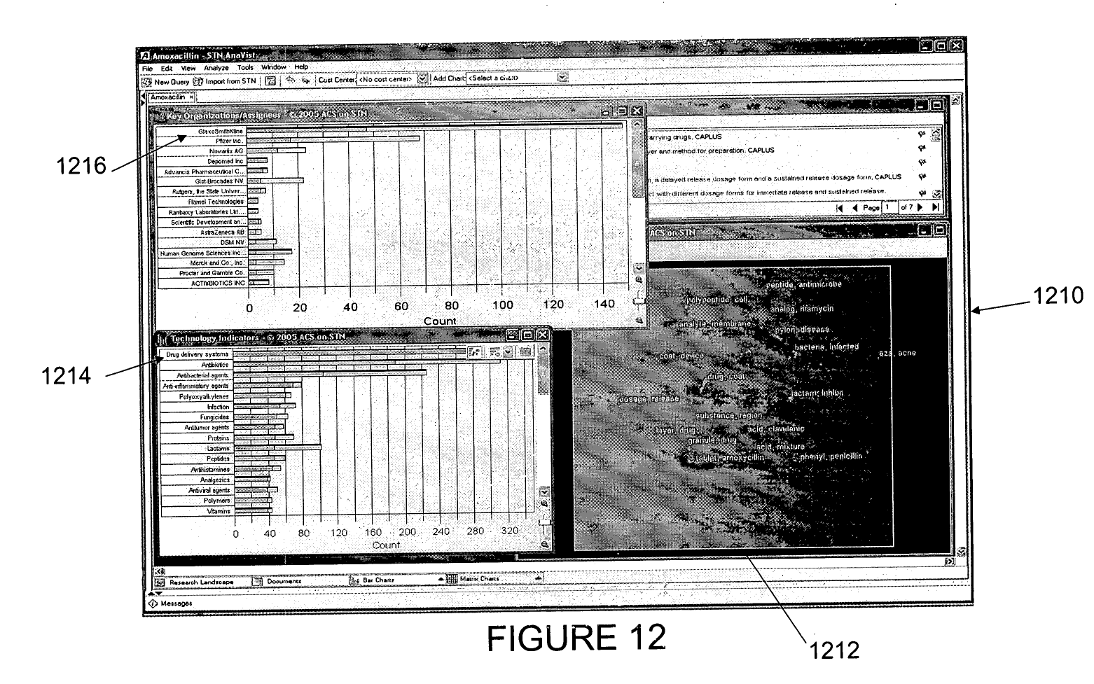

FIGS. 5A and 5B together are a screen display that simultaneously displays four of the display areas that are displayed by the system 200 once the initial large answer set has been retrieved. It should be noted that the disclosed elements have been distributed over FIGS. 5A and 5B for clarity even though they may be displayed in a single workspace or display. For example, see FIG. 12 for an example in which display areas similar to that shown in FIGS. 5A and 5B are displayed on a single display (or workspace).

Accordingly, display area 510 (shown in FIG. 5B) displays a research landscape map 510 in which the documents (retrieved in the large answer set) are mapped into clusters based, for example, on the relevant concept indicators that are associated with the documents or proxies used instead (for example, based on keywords associated with documents that are retrieved, for example, from an external database).

Display area 520 (shown in FIG. 5B) shows a document viewer in which any one of the retrieved documents can be viewed. When none of the documents is selected for viewing, the document viewer may show a list of the documents that can be sorted using indexes of interest to a user.

Display area 530 (shown in FIG. 5A) is an example of a one-dimensional display (a bar chart) in which information about the documents are displayed together with one attribute of interest associated with the documents. For example, if the documents are patents, the display area 530 may be used to display the key organizations that own the patents and the bars in the bar chart indicate the number of patents assigned to each organization.

Display area 540 (shown in FIG. 5A) is an example of a two-dimensional display (a matrix chart) in which information about the documents are displayed together with two attributes associated with the documents. For example, if the documents are patents, the display 540 may be used to display all the key organizations that own these patents together with the publication year associated with the documents. In this way, the display area not only provides information on which organizations are most involved in the documents or patents in the answer set but also the time frame in which these documents or patents have been published.

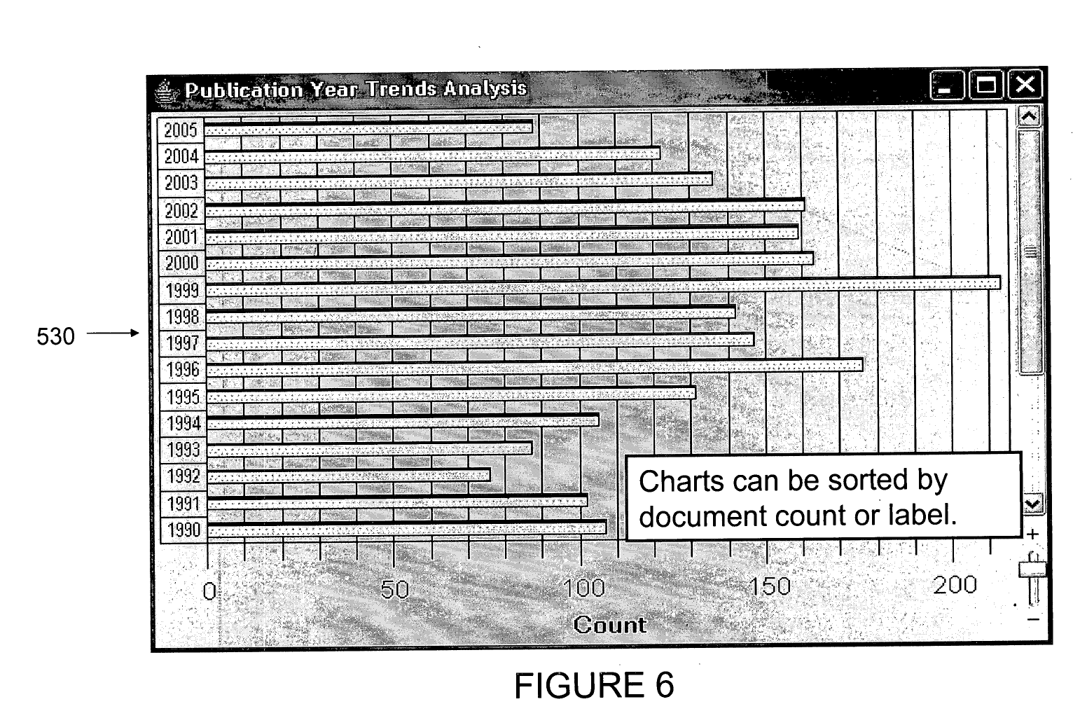

Further details of each of these display areas and their interaction is provided with respect to FIGS. 6-10. FIG. 6 provides an example of a bar chart 530 which is an example of a one-dimensional chart. As shown in the bar chart 530, the unstructured data is summarized along an attribute (or structured data) of publication year so that chronological trends of the selected documents can be visually analyzed. A user can easily change the attribute for arranging the data by selecting among an available set of attributes (or structured data). In certain embodiments, the user may right click on an empty area of the display chart to reveal a drop down list which provides the user with the various attributes that may be used to generate the one-dimensional bar chart.

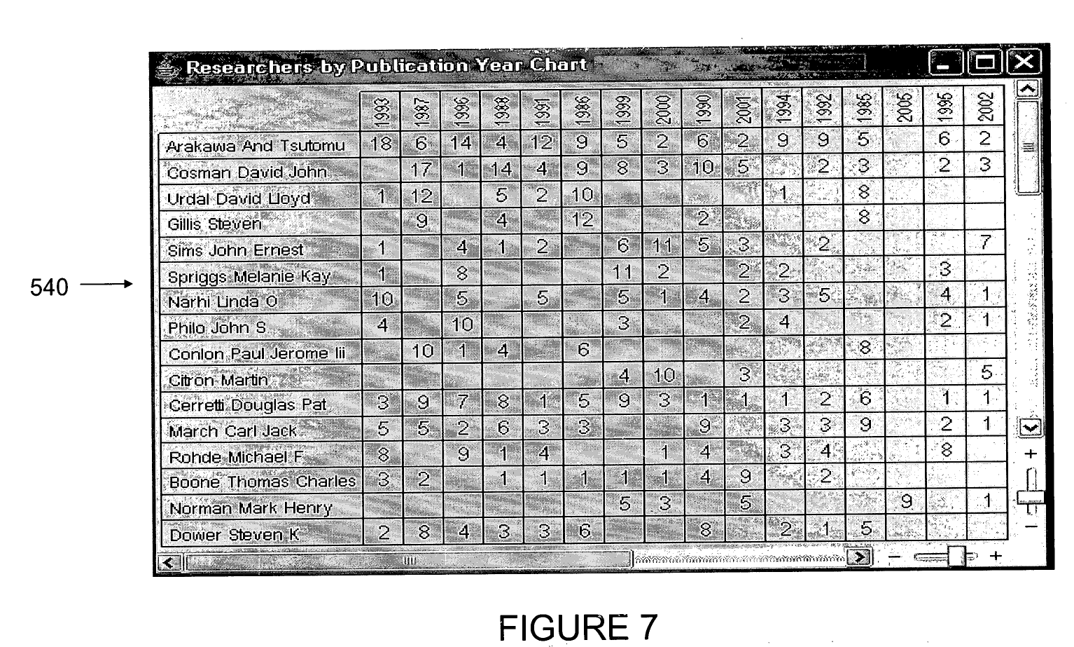

FIG. 7 displays a two-dimensional matrix chart 540 which displays the unstructured data (or documents) arranged in a matrix based on the two attributes (or structured data) of the researchers and the publication year. In this manner, the two-dimensional display provides additional information in which the underlying selected unstructured data (for example, a list of documents) can be visually analyzed.

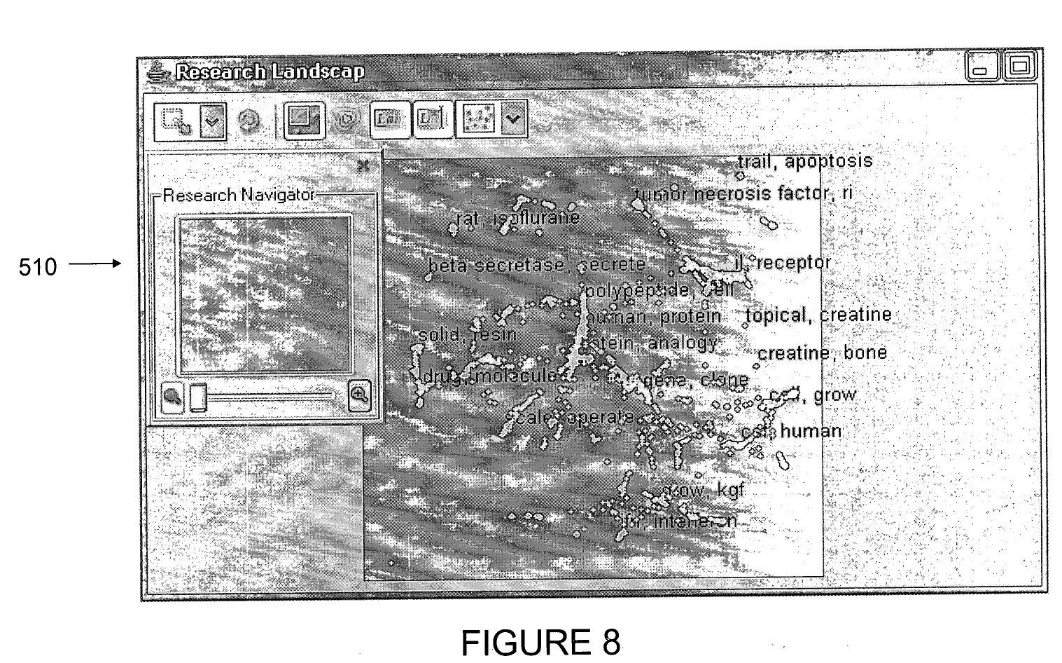

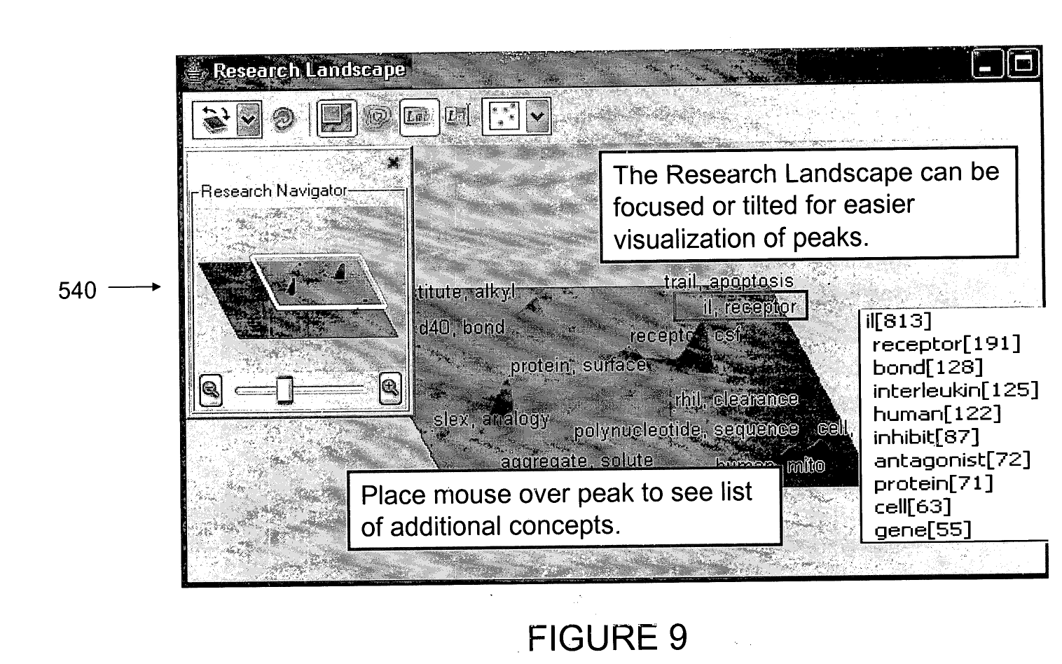

FIG. 8 displays a research landscape map 510 in which a list of documents are shown as data points that clustered based on various concept indicators. Documents in one cluster are similar to each other while the distance between clusters are an indication of the similarity or difference between the clusters. FIG. 9 is another view of the research landscape map 510 in which the plane of the map can be rotated so that the heights or peaks of the various clusters can be better visualized. As noted earlier, the heights or peak of a cluster correlates to the number of data points (or documents) that are associated with a particular cluster. The clustering technique used is non-exclusive so that each document can be located as a data point in the research landscape map 510 plane even if it does not belong to a specific cluster.

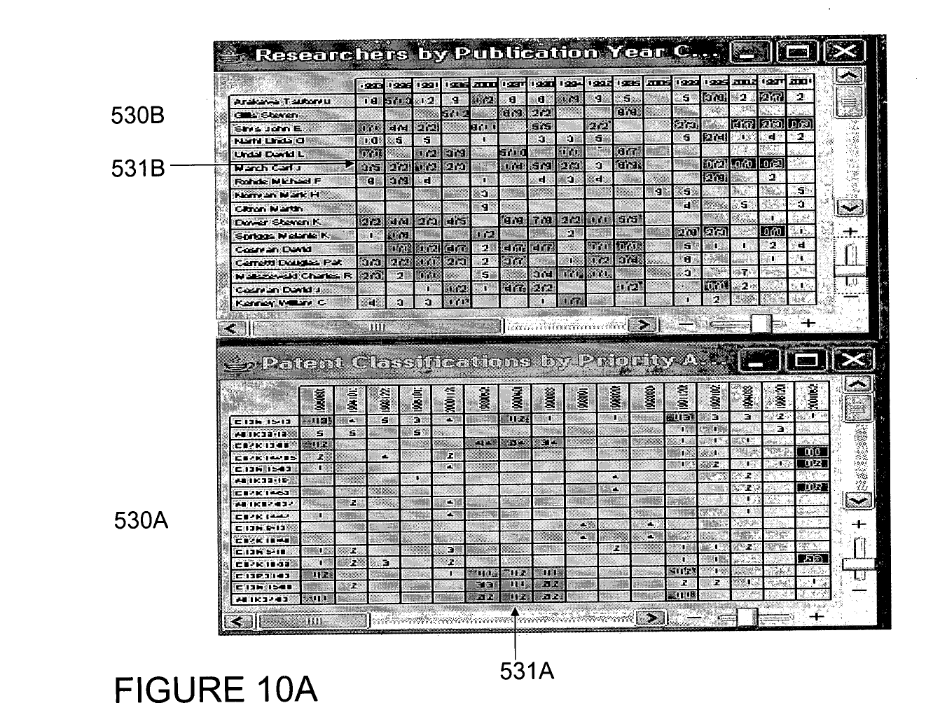

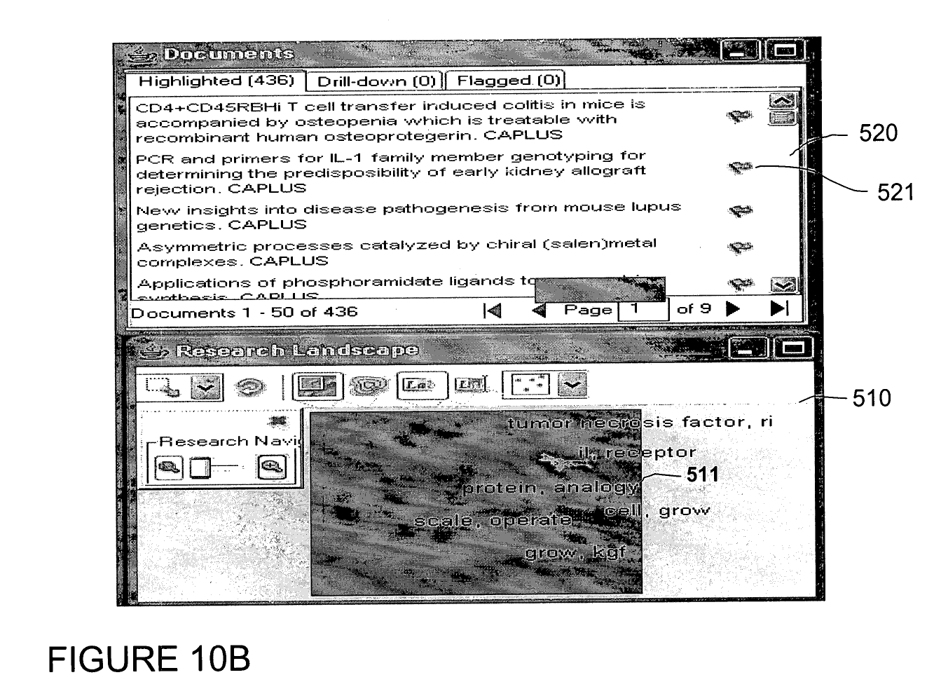

FIGS. 10A and 10B displays a workspace in which multiple display areas are shown so that the dynamic interoperation between the display areas may be visualized. It should be noted that the disclosed elements have been distributed over FIGS. 10A and B for clarity even though they may be displayed on a single display or workspace. See FIG. 12 for an example of similar elements being disclosed on a single workspace or display. A user selection 511 (shown in FIG. 10B) of a cluster in the research landscape map is shown visually by the selected clustered being highlighted (or by using a special color or any other similar technique that visually highlights the selected cluster 511).

In the two dimensional display area 530A (shown in FIG. 10B), only the documents that correspond to the selected cluster are highlighted in display area 530A. For example, the cells 531A (shown in FIG. 10A) are highlighted, as well as several other cells scattered throughout the matrix display 530A, to visually display where the documents corresponding to the selected cluster 511 in display area 510 fit in the matrix display 530A. Likewise, the specific cells (including cells 531B) in the matrix display 530B (shown in FIG. 10A) are highlighted to visually indicate where the documents corresponding to the selected cluster 511 in landscape map 510 fit in the matrix display 530B.

Furthermore, the document viewer display 520 typically displays a listing of only the documents that belong to the selected cluster 511 in landscape map 510. Document viewer display 520 also includes a flag icon 521 which allows a user to “flag” specific documents so that the document viewer display 520 keeps a flagged document irrespective of a selection state of the documents based on a selection or a change in selection of the documents in any one or more of the other display areas.

Therefore, each of the other display areas automatically and dynamically change its display to highlight or indicate data points that correspond to a selected list of documents in any one of the other display areas. Furthermore, whenever the selected data in any one of the display areas is changed, the other display areas also change automatically in substantially the same time to reflect the changes in the one display area (for example, based on the changed selection of documents). Therefore, a user can easily visually analyze not only the documents in a research landscape map but also the attributes associated with specific selected documents selected in the research landscape map 510.

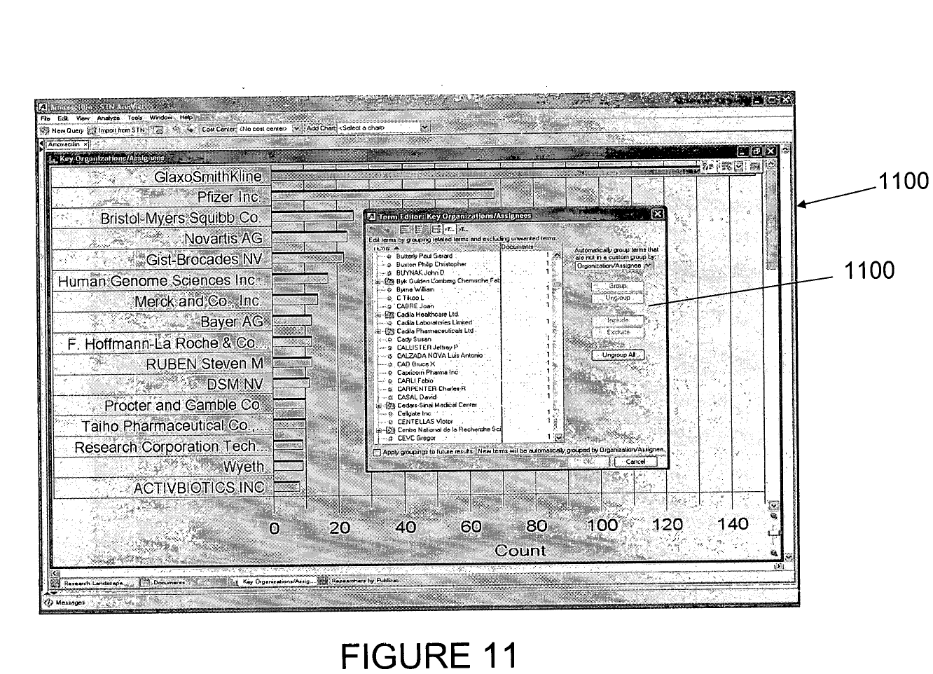

FIG. 11 shows a feature of the system 200 that allows a user to better clean-up the data that may be used the interactive display areas. For example, if a set of documents are retrieved and a user wishes to display these documents sorted by the assignees or owners of such documents, then the system 200 provides a window 1105 which allows the user to combine some of the organizations so that the documents are sorted and displayed to include the organizations as combined by the user. Therefore, if the structured data retrieved from the database includes separate entries for a company and its various subsidiaries, a user can use the window 1105 to combine the company and all or some of its subsidiaries so that all documents from the company and its subsidiaries are shown as belonging to one entity for the purposes of the one-dimensional bar chart display which displays the number of documents sorted based on the assignees or owners of the respective documents.

FIG. 12 is another example of the dynamic automatic interoperation between the various display areas of the system 200. The display area 1210 shows a landscape map for all documents retrieved from various databases responsive to a search for the term “Amoxycillin.” The documents are clustered based on various concept indicators associated with the retrieved documents and/or the particular search terms. If the user selects one of the clusters 1212 related to “tablet amoxicillin,” the selected cluster is highlighted and shown in the display area 1210. Substantially simultaneously the display in the display areas 1214 and 1216 also automatically change to reflect the selected state in the display area. Therefore, in display area 1214, portions of each of the bars in the bar charts are highlighted to indicate the proportion of documents that correspond to the selected state of the cluster 1212 in the display area 1210 and thereby provide an indication of the technology indicators that correspond to the selected cluster 1212 in display area 1210. Of course, bars that do not have any of the documents corresponding to the selected cluster are not highlighted at all. Likewise, the bars in display area 1216 are also partially highlighted to indicate the documents that correspond to the selected cluster 1212 in the display area 1210. Therefore, display area 1216 provides a visual indication of each of the assignees of the documents that correspond to the selected documents in the cluster 1212 in the display area 1210.

Therefore, some of the benefits of the display and analysis system and method disclosed herein is that accurate and cleaned data can be used to improve an answer set derived from a search of multiple relevant databases or data sources. The data can then be visualized in multiple displays which can each display one or more attributes of the data or documents in the answer set. Furthermore, intelligent analysis can be performed by changing the selections as well as the attributes so that each of the display areas automatically and dynamically change their displays to display data that corresponds to the documents in the particular selected state in one of the display areas. Furthermore, this process of selection of documents as well as choosing which attributes to use can be iteratively changed while the displays in all the other display areas change automatically to reflect the selection change in any one of the display areas.

Furthermore, it should be appreciated that it is within the abilities of one skilled in the art to program and configure a networked computer system to implement the method and system discussed earlier herein. The present invention also contemplates providing computer readable data storage medium with program code recorded thereon (i.e., software) for implementing the method steps described earlier herein. Programming the method steps discussed herein using custom and packaged software is within the abilities of those skilled in the art in view of the teachings disclosed herein. Furthermore, it should be recognized that data signals that embody one or more of the software instructions to implement the method disclosed herein are also within the scope of the present invention.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the features of the invention disclosed herein. Furthermore, it should be recognized that the present invention includes the methods and system disclosed herein together with the software and systems used to implement the methods and systems disclosed herein

What is claimed is:

1. A computer implemented method of relating structured data to unstructured data, comprising the steps of:
displaying unstructured data in a first display area;
displaying structured data related to the unstructured data in a second display area;
in response to a change in the display of one of the unstructured data in the first display area or the structured data in the second display area, automatically dynamically changing the display in the other of the first display area or the second display area to display changed data based on its relation to the changed data in the one of the first display area or the second display area.

2. The method according to claim 1, wherein the step of displaying the unstructured data includes performing a search of one or more databases to retrieve the unstructured data displayed in the first display area.

3. The method according to claim 2, wherein the step of displaying the structured data comprises retrieving structured data from the one or more databases based on its association with the unstructured data retrieved from the one or more databases.

4. The method according to claim 2, wherein the search comprises an enhanced search based on related terms to provided search terms.

5. The method according to claim 2, wherein the step of displaying structured data comprises deriving the structured data from the unstructured data retrieved from the one or more databases.

6. The method according to claim 1, wherein the step of displaying structured data is performed automatically responsive to the step of displaying unstructured data.

7. The method according to claim 1, wherein the step of displaying the unstructured data comprises displaying a cluster map of retrieved data in which similar data based on one or more attributes of the retrieved data are grouped together in similar clusters.

8. The method according to claim 1, wherein the step of displaying the unstructured data comprises displaying a classification scheme of the retrieved data in which similar data based on one or more attributes of the retrieved data are grouped together in similar classifications.

9. The method according to claim 1, wherein the step of displaying structured data comprises displaying a one-dimensional display based on an attribute of the retrieved data displayed in the first display area.

10. The method according to claim 1, wherein the step of displaying the structured data comprises displaying a two-dimensional display based on two attributes of the retrieved data displayed in the first display area.

11. The method according to claim 7, wherein the clusters are displayed in a three-dimensional display in the first display area.

12. The method according to claim 11, wherein the distance between the clusters indicates a measure of similarity in the data included in the respective clusters.

13. The method according to claim 7, further comprising:
receiving a selection of one or more of the clusters displayed in the first display area; and
automatically dynamically altering the display of the structured data in the second display area to correspond to the selected one or more clusters in the first display area.

14. The method according to claim 8, further comprising:
receiving a selection of one or more of the classifications displayed in the first display area; and
automatically dynamically altering the display of the structured data in the second display area to correspond to the selected one or more classifications in the first display area.

15. The method according to claim 1, wherein the first display area and the second display area are respective windows in a graphical user interface on a computer display.

16. The method according to claim 15, wherein the first display area and the second display area are displayed coordinated and displayed across two or more computer display screens.

17. The method according to claim 1, wherein the unstructured data comprises documents stored in one or more databases and the structured data comprises one or more attributes associates with the documents stored in the one or more databases.

18. The method according to claim 5, further comprising:
harvesting a subset of terms from the unstructured data which comprises documents retrieved from one or more databases;
harmonizing the harvested terms to a lexicon to derive a document vector;
storing a document vector for each document in a searchable database wherein the document vector contains concept indicators associated with each document; and
wherein the step of displaying a cluster map includes a similarity calculation based on the concept indicators included with the document vector associated with each document retrieved in a search.

19. The method according to claim 18, wherein the step of displaying unstructured data in a first display area comprises displaying a three dimensional map in which larger clusters based on concept indicators are displayed as larger peaks compared to smaller clusters which are displayed as smaller peaks.

20. The method according to claim 1, further comprising automatically displaying other structured data in a third display area related to the unstructured data in the first display area.

21. The method according to claim 20, wherein the display in any two of the first display area, the second display area, and the third display area are automatically dynamically changed to reflect a changed display in the other of the first display area, the second display area, and the third display area.

22. The method according to claim 21, wherein the first display area displays a cluster map of documents clustered based on concept indicators associated with each document, the second display area displays a one-dimensional display that displays one attribute associated with the documents in the cluster map displayed in the first display area, and the third display area displays a multi-dimensional display that displays at least two attributes associated with the documents in the cluster map displayed in the first display area.

23. The method according to claim 22, further comprising:
receiving a selection of a subset of data in one of the first display area, second display area, or the third display area;
automatically dynamically highlighting the data in the others of the first, second, and third display areas that correspond to the selected subset of data in the one of the first display area, the second display area, and the third display area.

24. The method according to claim 1, further comprising a document viewer display area in which specific documents included in the unstructured data or lists of documents included in the unstructured data may be viewed, wherein the list of documents displayed in the document viewer display area corresponds to a selection made in one of the first display area or the second display area.

25. The method according to claim 24, wherein the document viewer display area includes a flagged tab by which a user can flag documents that are then always listed in the document viewer display area irrespective of any selection made in either the first display area or the second display area.

26. A system for relating structured data to unstructured data, comprising:
a display unit configured to display unstructured data in a first display area;
the display unit also configured to display structured data related to the unstructured data in a second display area; and
a processing unit configured, in response a change in the display of one of the unstructured data in the first display area or the structured data in the second display area, to automatically dynamically change the display in the other of the first display area or the second display area to display changed data based on its relation to the changed data in the one of the first display area or the second display area.

27. The system according to claim 26, in which the processing unit is configured to perform a search of one or more databases to retrieve unstructured data displayed in the first display area.

28. The system according to claim 26, wherein the processing unit is configured to display the structured data automatically responsive to displaying unstructured data.

29. The system according to claim 26, wherein the processing unit is configured to display on the display unit, the structured data as a cluster map of retrieved data in which similar data based on or more attributes of the retrieved data are grouped together in similar clusters.

30. The system according to claim 26, wherein the processing unit is configured to display a one-dimensional display on the display unit based on an attribute of the retrieved data displayed in the first display area.

31. The system according to claim 26, wherein the processing unit is configured to display a two-dimensional display on the display unit based on two attributes of the retrieved data displayed in the first display area.

32. The system according to claim 29, wherein the processing unit is configured to receive a selection of one more of the clusters displayed in the first display area and automatically dynamically altering the display of the structured data in the second display area to correspond to the selected one or more clusters in the first display area.

33. The system according to claim 26, wherein the first display area and the second display area are windows in a graphical user interface on the display unit.

34. The system according to claim 26, wherein the processing unit is further configured to:
harvest a subset of terms from the unstructured data which comprises documents retrieved from one or more databases;
harmonize the harvested terms to a lexicon to derive a document vector; and
store a document vector for each document in a searchable database wherein the document vector contains concept indicators associated with each document;
wherein the document vector is used in clustering or classification of the document.

35. The system according to claim 26, wherein the processing unit is configured to automatically dynamically change the display in any two of the first display area, the second display area, and a third display area to reflect a changed display in the other of the first display area, the second display area, and the third display area.

36. A computer readable medium having program code recorded thereon that, when executed on a computing system, relates structured data to unstructured data, the program code comprising:
code for displaying unstructured data in a first display area;
code for displaying structured data related to the unstructured data in a second display area;
code for, in response a change in the display of one of the unstructured data in the first display area or the structured data in the second display area, automatically dynamically changing the display in the other of the first display area or the second display area to display changed data based on its relation to the changed data in the one of the first display area or the second display area.

37. The computer readable medium according to claim 36, wherein the code for displaying unstructured data in a first data area includes code for performing a search for of one or more databases to retrieve the unstructured data displayed in the first display area.

38. The computer readable medium according to claim 36, wherein the code for displaying structured data automatically displays the structured data responsive to the display of the unstructured data.

39. The computer readable medium according to claim 36, wherein the code for displaying unstructured data displays a cluster map of retrieved data in which similar data based on one or more attributes of the retrieved data are grouped together in similar clusters.

40. The computer readable medium according to claim 36, further comprising code for receiving a selection of one or more of the clusters displayed in the first display area; and
code for automatically dynamically altering the display of the structured data in the second display area to correspond to the selected one or more clusters in the first display area.

41. The computer readable medium according to claim 36, further comprising:
code for harvesting a subset of terms from the unstructured data which comprises documents retrieved from one or more databases;
code for harmonizing the harvested terms to a lexicon to derive a document vector; and
code for storing a document vector for each document in a searchable database wherein the document vector contains concept indicators associated with each document;
wherein the document vector is used in clustering or classification of the document.

42. The computer readable medium according to claim 36, further comprising code for automatically dynamically changing the display in any two of the first display area, the second display area, and a third display area to reflect a changed display in the other of the first display area, the second display area, and the third display area.

43. A system for relating structured data to unstructured data, comprising:
means displaying unstructured data in a first display area;
means for displaying structured data related to the unstructured data in a second display area; and
means, in response a change in the display of one of the unstructured data in the first display area or the structured data in the second display area, for automatically dynamically changing the display in the other of the first display area or the second display area to display changed data based on its relation to the changed data in the one of the first display area or the second display area.

44. A system for relating structured data to unstructured data, comprising:
a display unit configured to display unstructured data in a first display area;
the display unit also configured to display structured data related to the unstructured data in a second display area; and
a processing unit configured, in response a change in the display of one of the unstructured data in the first display area or the structured data in the second display area, to automatically dynamically change the display in the other of the first display area or the second display area to display changed data based on its relation to the changed data in the one of the first display area or the second display area,
wherein display unit comprises a graphical user interface which independently controls and formats the first display area and the second display area.
